(19) United States
(12) Patent Application Publication
(10) Pub. No.: US 2007/0041509 A1
(43) Pub. Date: Feb. 22, 2007

(54) Telephone apparatus, telephone switchboard, and telephone line connection method

(75) Inventor: Hiroshi Sawakuri, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NEC INFRONTIA CORPORATION

(21) Appl. No.: 11/436,657

(22) Filed: May 19, 2006

(30) Foreign Application Priority Data
May 20, 2005 (JP) 2005-148012

(51) Int. Cl. H04M 1/24

(52) U.S. Cl. 379/27.01; 379/211.01

(57) ABSTRACT

The telephone apparatus prevents a ringer sound from being produced from a handset after the handset is off-hook by an incoming call while using a conventional subscriber line of a central telephone exchange. A telephone apparatus includes an off-hook detection unit that detects that a handset is off-hook in response to an incoming call, a hook switch control unit that changes over a hook switch from an OFF state to an ON state when the off-hook detection unit detects that the handset is off-hook, and a connection unit that connects a loudspeaker to a line after passage of a predetermined time since the off-hook detection unit detects that the handset is off-hook.

### BACKGROUND OF THE INVENTION

1. Field of the Invention

The present invention relates to a telephone apparatus, a telephone switchboard, and a telephone line connection method for holding a conversation or the like through a public telephone network. More specifically, the present invention relates to a telephone apparatus, a telephone switchboard, and a telephone line connection method having ringer-related characteristics.

2. Description of the Related Art

FIG. 1 is a circuit diagram of a telephone apparatus according to a conventional example. FIG. 2 is a circuit diagram of ringer-related constituent elements of a subscriber circuit of a central telephone exchange and those of the telephone apparatus.

Referring to FIGS. 1 and 2, terminals L1 and L2 of the telephone apparatus are connected to the subscriber circuit. If the telephone apparatus receives a telephone call, switches SWA and SWB of the subscriber circuit are turned on. Between the terminals L1 and L2, a direct-current (DC) voltage generated by a DC power supply V_{DC} and an alternating-current (AC) voltage generated by an AC power supply V_{AC} are applied. If so, a capacitor C1 blocks the DC voltage and only the AC voltage is applied to a ringer B. The ringer B thereby outputs a ringer sound. A frequency of this AC voltage is 16 hertz. In addition, after this AC voltage continues to be applied for one second, application thereof is halted for two seconds. This operation is performed repeatedly.

If a handset is off-hook, hook switches HS1 and HS2 of the telephone apparatus are turned on. Accordingly, within the telephone apparatus, a short-circuit path via a switch D1 (which is turned on), a transformer L, a loudspeaker T, and the switch HS2 is formed between the terminals L1 and L2. If so, a DC voltage is generated on both ends of a resistor R_{A} of the subscriber circuit. If detecting that the DC voltage is generated on the both ends of the resistor R_{A}, a control unit (not shown) of the subscriber circuit turns off the switches SWA and SWB. The ringer B thereby finishes outputting the ringer sound.

Thereafter, the telephone apparatus turns into a conversation state, and starts transmitting and receiving a voice and the like to and from a telephone apparatus of a conversation partner through a feed switching, testing, feeding, monitoring, two-wire/four-wire conversion, and coding units S of the subscriber circuit.

However, as shown in FIG. 3, during a period since the hook switches HS1 and HS2 are turned on until the switches SWA and SWB are turned off and stopped outputting the ringer sound, a delay time is generated resulting from an operating rate of the control unit of the subscriber circuit, a transmission time for transmitting a signal over the telephone line, and the like. If a time since a user leaves the handset off-hook until the user holds the handset to the user's ear is longer than this delay time, no problem occurs. If not, the AC voltage generated by the AC power supply V_{AC} drives the loudspeaker T to output the ringer sound. As a result, the user hears the ringer sound from the handset held to the user's ear. In this case, the user hears the ringer sound offensive noise.

Japanese Patent Application Laid-Open No. 57-206151 discloses the invention to solve the problems in an apparatus in a central telephone exchange.

### SUMMARY OF THE INVENTION

It is an object of the present invention to provide a telephone apparatus, a telephone switchboard, and a telephone line connection method capable of preventing a ringer sound from being produced from a handset after the handset is off-hook by an incoming call while using a conventional subscriber line of a central telephone exchange.

According to a first aspect of the present invention, there is provided a telephone apparatus comprising: response detection means for detecting a response to an incoming call; response notification means for notifying the response to a station when the response detection means detects the response; and connection means for connecting a loudspeaker to a line after passage of a predetermined time since the response detection means detects the response.

According to a second aspect of the present invention, there is provided a telephone switchboard comprising: response detection means for detecting a response to an incoming call; response notification means for notifying the response to a station when the response detection means detects the response; and connection means for connecting a loudspeaker to a line after passage of a predetermined time since the response detection means detects the response.

According to a third aspect of the present invention, there is provided a telephone line connection method comprising a response detection step of detecting a response to an incoming call; a response notification step of notifying the response to a station when the response is detected at the response detection step; and a connection step of connecting a loudspeaker to a telephone line after passage of a predetermined time since the response is detected at the response detection step.

According to a fourth aspect of the present invention, there is provided a telephone apparatus comprising: an off-hook detection unit that detects that a handset is off-set in response to an incoming call; a hook switch control unit that changes over a hook switch from an OFF state to an ON state when the off-hook detection unit detects that the handset is off-hook; and connection means for connecting a loudspeaker to a line after passage of a predetermined time since the off-hook detection unit detects that the handset is off-hook.

According to a fifth aspect of the present invention, there is provided a telephone line connection method comprising: an off-hook detection step of detecting that a handset is off-set in response to an incoming call; a hook switch control step of changing over a hook switch from an OFF state to an ON state when it is detected that the handset is off-hook at the off-hook detection step; and a connection step of connecting a loudspeaker to a line after passage of a predetermined time since it is detected that the handset is off-hook at the off-hook detection step.

According to a sixth aspect of the present invention, there is provided a telephone switchboard comprising: an off-hook detection unit that detects that a handset of an extension terminal is off-hook in response to an incoming call; response notification means for notifying a response to a station when the off-hook detection unit detects that the handset of the extension terminal is off-hook; and connection means for connecting a conversation unit of a station line interface unit to a conversation unit of an extension interface unit after passage of a predetermined time since the off-hook detection unit detects that the handset of the extension terminal is off-hook.

According to a seventh aspect of the present invention, there is provided a telephone line connection method, comprising: an off-hook detection step of detecting that a handset of an extension terminal is off-hook in response to an incoming call; a response notification step of notifying a response to a station when it is detected that the handset of the extension terminal is off-hook at the off-hook detection step; and a connection step of connecting a conversation unit of a station line interface unit to a conversation unit of an extension interface unit after passage of a predetermined time since it is detected that the handset of the extension terminal is off-hook at the off-hook detection step.

### BRIEF DESCRIPTION OF THE DRAWINGS

FIG. 1 is a circuit diagram of a configuration of a telephone apparatus according to a conventional example;

FIG. 2 is a circuit diagram of a configuration of a subscriber circuit of a central telephone exchange;

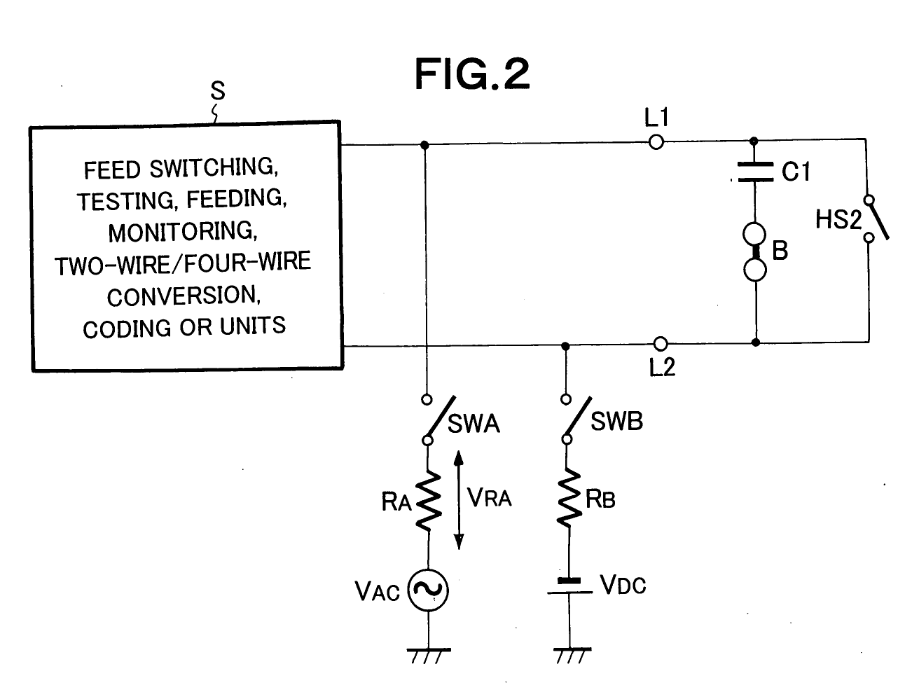

FIG. 3 is a timing chart of operations performed when a handset is off-hook according to the conventional example;

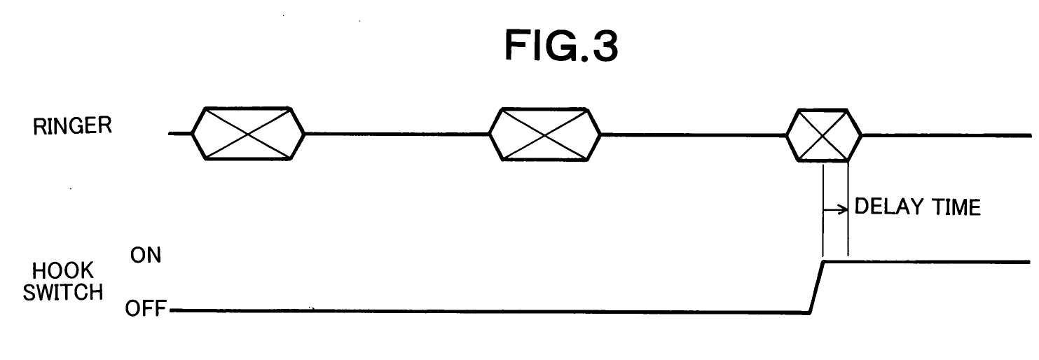

FIG. 4 is a circuit diagram of a configuration of a telephone apparatus according to a first embodiment of the present invention;

FIG. 5 is a timing chart of operations performed when a handset is off-hook according to the first embodiment;

FIG. 6 is a flowchart of a telephone line connection method according to the first embodiment;

FIG. 7 is a block diagram of a configuration of a telephone switchboard according to a second embodiment of the present invention; and

FIG. 8 is a block diagram of a configuration of a telephone switchboard according to a third embodiment of the present invention.

### DESCRIPTION OF THE PREFERRED EMBODIMENTS

Preferred embodiments of the present invention will be described hereinafter with reference to the drawings.

(First Embodiment)

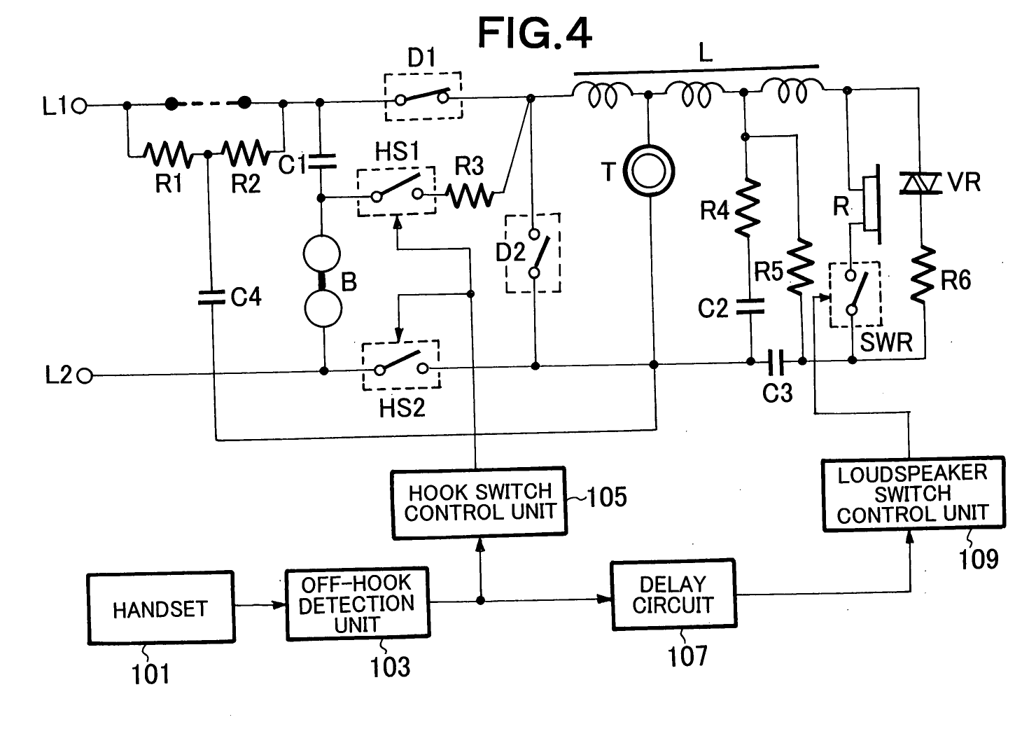

FIG. 4 is a circuit diagram of a configuration of a telephone apparatus according to the first embodiment of the present invention.

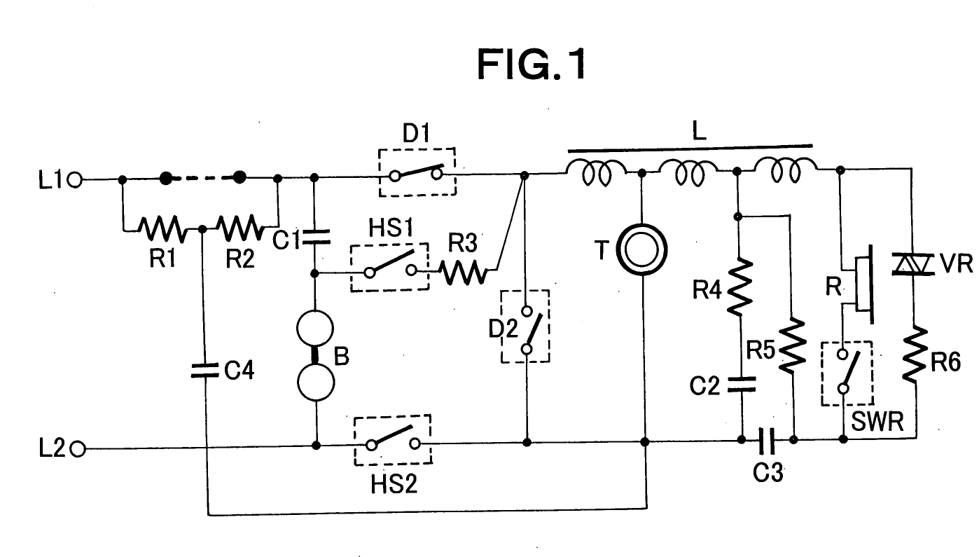

The telephone apparatus according to this embodiment differs from the telephone apparatus according to the conventional example shown in FIG. 1 in that the apparatus additionally includes an off-hook detection unit 103, a hook switch control unit 105, a delay circuit 107, a loudspeaker switch SWR, and a loudspeaker switch control unit 109.

The same constituent elements of the telephone apparatus according to this embodiment as those shown in FIG. 1 are well known as disclosed in, for example, Japanese Patent Application Laid-Open No. 61-148944. Therefore, they will not be repeatedly described herein.

The off-hook detection unit 103 detects that a handset 101 is off-hook. The hook switch control unit 105 changes over each of off-hook switches HS1 and HS2 from an OFF state to an ON state if the off-hook detection unit 103 detects that the handset 101 is off-hook. The delay circuit 107 delays a timing at which the handset 101 is off-hook as detected by the off-hook detection unit 103. The loudspeaker switch SWR is connected in series to a loudspeaker R. If the loudspeaker switch SWR is turned off, no voltage is applied between both ends of the loudspeaker R. The loudspeaker switch control unit 109 changes over the loudspeaker switch SWR from an OFF state to an ON state at the timing delayed by the delay circuit 107.

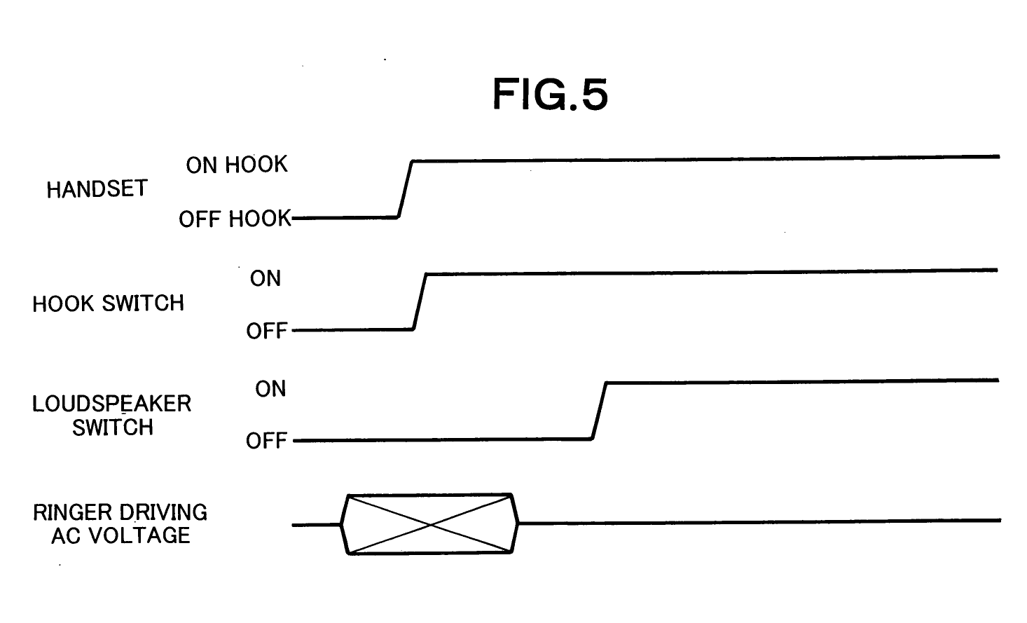

FIG. 5 is a timing chart of operations performed by the telephone apparatus shown in FIG. 4.

Referring to FIG. 5, if the handset 101 is left off-hook, each of the hook switches HS1 and HS2 is changed from an OFF state to an ON state after negligible delay time. Thereafter, application of an ringer driving AC voltage is stopped by the operation of the subscriber circuit stated above. During a period since the handset 101 is left off-hook until the application of the ringer driving AC voltage is stopped, the delay time occurs. The loudspeaker switch SWR is changed over from an OFF state to an ON state after the application of the ringer driving AC voltage is stopped. Accordingly, the loudspeaker R is not driven by the ringer driving AC voltage that continues to be applied for a while even after the handset 101 is off-hook.

The delay time of the delay circuit 107 will now be described. If the handset 101 is off-hook while a ringer sound is produced, the AC voltage for producing a next ringer sound is not normally input to the telephone apparatus from the subscriber circuit. Due to this, if only an instance in which the handset 101 is off-hook while the ringer sound is produced is considered, only a part of the ringer driving AC voltage, which is currently applied, to correspond to a period after the handset 101 is off-hook is eliminated. Therefore, it suffices the delay time of the delay circuit 107 is set to be than one second or more. On the other hand, if a time required until a conversation starts is considered, the delay time of the delay circuit 107 is preferably as short as possible. Therefore, it suffices that the delay time of the delay circuit 107 is set to be one second.

However, if the handset 101 is off-hook just before the ringer sound is produced and the delay time of the delay circuit 107 is set to be one second, then the ringer driving AC voltage for producing the next ringer sound may possibly be applied and the loudspeaker R may possibly be driven in response to a trailing part of this AC voltage. Considering this probability, it is preferable that the delay time of the delay circuit 107 is set slightly longer than one second (e.g., 1.5 seconds).

If the handset 101 is off-hook just after the ringer sound finishes to be produced, the ringer driving AC voltage for producing the next ringer sound is not normally applied. Therefore, no problem occurs even if the delay time of the delay circuit 107 is set to be two seconds or less.

Considering all these respects, it suffices that the delay time of the delay circuit 107 falls within a range from one second to two seconds.

Alternatively, a circuit that measures a time since the handset 101 is off-hook until application of the ringer driving AC voltage is stopped may be provided in the telephone apparatus after the telephone apparatus is installed in a house or the like. In addition, the time measured by this circuit or a time to which a margin is added to the measured time may be set as the delay time of the delay circuit 107.

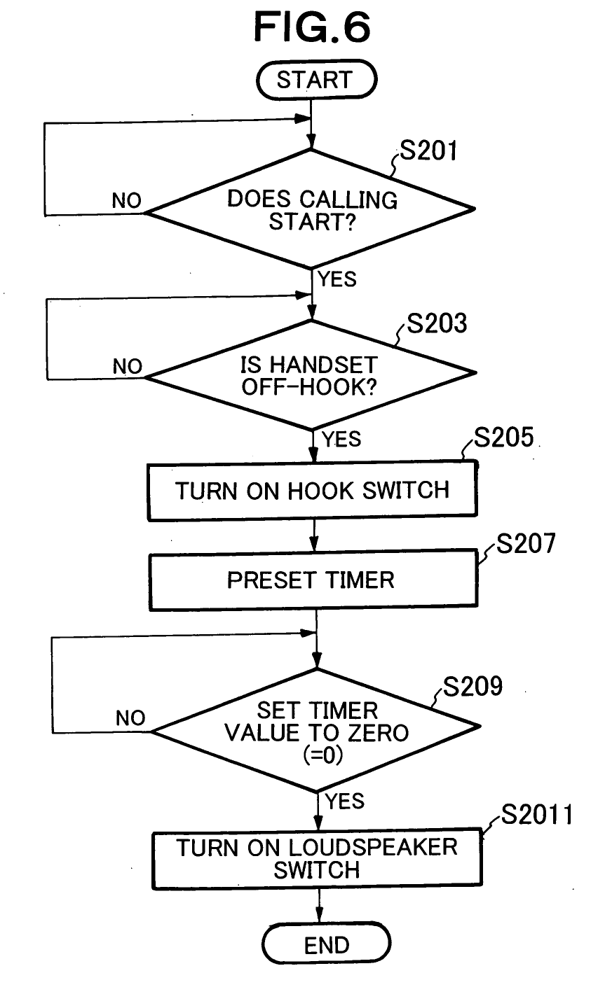

FIG. 6 is a flowchart of operations if a software program controls the hook switches HS1 and HS2 and the loudspeaker switch SWR.

Referring to FIG. 6, the telephone apparatus waits until calling starts (at a step S201). This operation is performed by, for example, detecting a voltage generated by a power supply V_{AC} or a power supply V_{DC}.

The telephone apparatus waits until the handset 101 is off-hook (at a step S203).

Each of the hook switches HS1 and HS2 is changed over from the OFF state to the ON state (at a step S205).

A count value of a countdown timer is preset to a predetermined value (at a step S207).

The telephone apparatus waits until the count value of the countdown timer is equal to zero (at a step S209).

The loudspeaker switch SWR is changed over from the OFF state to the ON state (at a step S211).

(Second Embodiment)

The first embodiment is an improvement of the telephone apparatus installed in a house or the like. The second embodiment is an improvement of a telephone switchboard installed in a company office or the like similarly to the first embodiment.

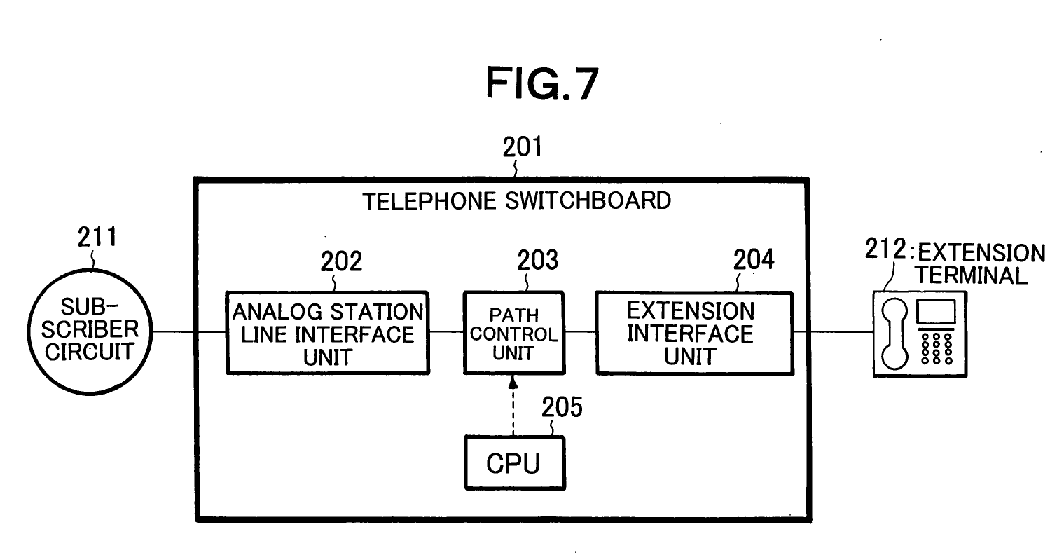

Referring to FIG. 7, a telephone switchboard 201 according to the second embodiment includes an analog station line interface unit 202, a path control unit 203, an extension interface unit 204, and a CPU 205.

The analog station line interface unit 202 is connected to a subscriber circuit 211 of a central telephone exchange. The extension interface unit 204 is connected to an extension terminal 212. The path control unit 203 connects the analog station line interface unit 202 to the extension interface unit 204. The CPU 205 controls the path control unit 203.

If a call is incoming at the extension terminal 212 from the subscriber circuit 211 via the telephone switchboard 201 and a handset of the extension terminal 212 is left off-hook, the analog station line interface unit 202 transmits a response indicating that the handset of the extension terminal 212 is off-hook to the subscriber circuit 211. The CPU 205 controls the path control unit 203 after passage of a predetermined time since the unit 202 transmits the response to the subscriber circuit 211, thereby connecting a conversation unit of the analog station line interface unit 202 to that of the extension interface unit 204.

By doing so, it is possible to prevent a ringer sound from being output from a loudspeaker of the extension terminal 212.

(Third Embodiment)

The third embodiment is a modification of the second embodiment.

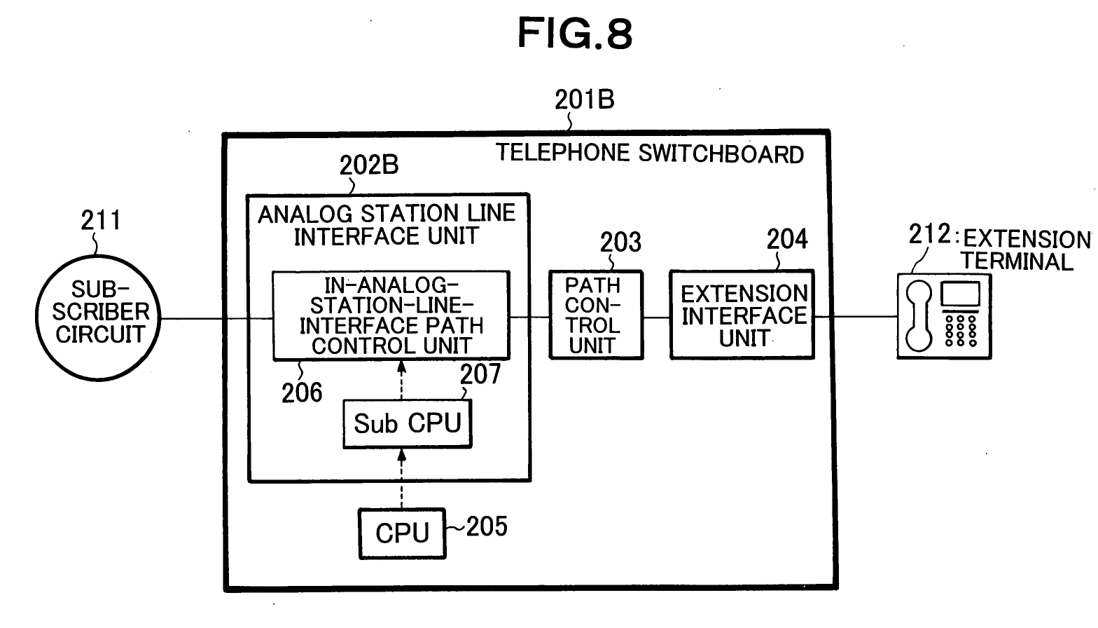

Referring to FIG. 8, a telephone switchboard 201B according to the third embodiment includes an analog station line interface unit 202B, the path control unit 203, the extension interface unit 204, and the CPU 205. The analog station line interface unit 202B includes an in-analog-station-line-interface path control unit 206 and a Sub CPU 207.

The analog station interface unit 202B is connected to the subscriber circuit 211 of the central telephone exchange. The extension interface unit 204 is connected to the extension terminal 212. The path control unit 203 connects the analog station interface unit 202B to the extension interface unit 204. The CPU 205 includes the Sub CPU 207. The Sub CPU 207 controls the in-analog-station-line-interface path control unit 206.

If a call is incoming at the extension terminal 211 from the subscriber circuit 211 via the telephone switchboard 201 and the handset of the extension terminal 212 is left off-hook, the analog station line interface unit 202B transmits a response indicating that the handset of the extension terminal 212 is off-hook to the subscriber circuit 211. The CPU 205 controls the in-analog-station-line-interface path control unit 206 in the analog station line interface through the Sub CPU 207 after passage of the predetermined time since the unit 202B transmits the response to the subscriber circuit 211, thereby connecting a conversation unit of the analog station line interface unit 202B to that of the extension interface unit 204.

By doing so, it is possible to prevent the ringer sound from being output from the loudspeaker of the extension terminal 212.

According to the present invention, the telephone apparatus includes the response detection means for detecting a response to an incoming call, the response notification means for notifying the response to a station when the response detection means detects the response, and the connection means for connecting a loudspeaker to a line after passage of a predetermined time since the response detection means detects the response. Therefore, the telephone apparatus can prevent a ringer sound from being produced from the handset after the handset is off-hook by an incoming call while using a conventional subscriber line of a central telephone exchange.

What is claimed is:

1. A telephone apparatus comprising:
response detection means for detecting a response to an incoming call;
response notification means for notifying the response to a station when the response detection means detects the response; and
connection means for connecting a loudspeaker to a line after passage of a predetermined time since the response detection means detects the response.

2. A telephone switchboard comprising:
response detection means for detecting a response to an incoming call;
response notification means for notifying the response to a station when the response detection means detects the response; and
connection means for connecting a loudspeaker to a line after passage of a predetermined time since the response detection means detects the response.

3. A telephone line connection method comprising:
a response detection step of detecting a response to an incoming call;
a response notification step of notifying the response to a station when the response is detected at the response detection step; and
a connection step of connecting a loudspeaker to a line after passage of a predetermined time since the response is detected at the response detection step.

4. A telephone apparatus comprising:
an off-hook detection unit that detects that a handset is off-set in response to an incoming call;
a hook switch control unit that changes over a hook switch from an OFF state to an ON state when the off-hook detection unit detects that the handset is off-hook; and
connection means for connecting a loudspeaker to a line after passage of a predetermined time since the off-hook detection unit detects that the handset is off-hook.

5. A telephone line connection method comprising:
an off-hook detection step of detecting that a handset is off-set in response to an incoming call;
a hook switch control step of changing over a hook switch from an OFF state to an ON state when it is detected that the handset is off-hook at the off-hook detection step; and
a connection step of connecting a loudspeaker to a telephone line after passage of a predetermined time since it is detected that the handset is off-hook at the off-hook detection step.

6. A telephone switchboard comprising:
an off-hook detection unit that detects that a handset of an extension terminal is off-hook in response to an incoming call;
response notification means for notifying a response to a station when the off-hook detection unit detects that the handset of the extension terminal is off-hook; and
connection means for connecting a conversation unit of a station line interface unit to a conversation unit of an extension interface unit after passage of a predetermined time since the off-hook detection unit detects that the handset of the extension terminal is off-hook.

7. A telephone line connection method, comprising:
an off-hook detection step of detecting that a handset of an extension terminal is off-hook in response to an incoming call;
a response notification step of notifying a response to a station when it is detected that the handset of the extension terminal is off-hook at the off-hook detection step; and
a connection step of connecting a conversation unit of a station line interface unit to a conversation unit of an extension interface unit after passage of a predetermined time since it is detected that the handset of the extension terminal is off-hook at the off-hook detection step.
